(19) United States
(12) Patent Application Publication
(10) Pub. No.: US 2005/0259747 A1
(43) Pub. Date: Nov. 24, 2005

(54) Context adaptive binary arithmetic code decoder for decoding macroblock adaptive field/frame coded video data

(75) Inventor: Reinhard Schumann, Exeter, NH (US)

Correspondence Address: MCANDREWS HELD & MALLOY, LTD, 500 WEST MADISON STREET, SUITE 3400, CHICAGO, IL, 60661, US

(73) Assignee: Broadcom Advanced Compression Group, LLC

(21) Appl. No.: 10/917,914

(22) Filed: Aug. 13, 2004

Related U.S. Application Data
(60) Provisional application No. 60/573,283, filed on May 21, 2004.

(51) Int. Cl. H04N 7/12

(52) U.S. Cl. 375/240.25; 375/240.24

(57) ABSTRACT

Described herein is a context adaptive binary arithmetic code decoder for decoding macroblock adaptive field/frame coded video data. In one embodiment, there is presented a video system. The video system comprises a CABAC decoder and neighbor buffer. The CABAC decoder decodes CABAC symbols associated with a portion of a picture, thereby resulting in decoded CABAC symbols. The neighbor buffer stores information from decoded CABAC symbols associated with another portion of the picture, said another portion being adjacent to the portion. The CABAC decoder decodes the CABAC symbols based on the information about the another portion of the picture.

### RELATED APPLICATIONS

This application claims priority to “CONTEXT ADAPTIVE binary arithmetic code DECODER FOR DECODING MACROBLOCK ADAPTIVE FIELD/FRAME CODED VIDEO DATA”, Provisional Application for U.S. Patent Ser. No. 60/573,283, filed May 21, 2004 by Schumann, which is incorporated herein by reference in its entirety for all purposes.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Encoding standards often use recursion to compress data. In recursion, data is encoded as a mathematical function of other previous data. As a result, when decoding the data, the previous data is needed.

An encoded picture is often assembled in portions. Each portion is associated with a particular region of the picture. The portions are often decoded in a particular order. For decoding some of the portions, data from previously decoded portions is needed.

A video decoder typically includes integrated circuits for performing computationally intense operations, and memory. The memory includes both on-chip memory and off-chip memory. On-chip memory is memory that is located on the integrated circuit and can be quickly accessed. Off-chip memory is usually significantly slower to access than on-chip memory.

During decoding, storing information from portions that will be used for decoding later portions in on-chip memory is significantly faster than storing the information off-chip. However, on-chip memory is expensive, and consumes physical area of the integrated circuit. Therefore, the amount of data that on-chip memory can store is limited. In contrast, decoded video data generates very large amounts of data. Therefore, it may be impractical to store all of the decoded data on-chip.

Some of the data needed for decoding a portion is typically contained in the neighboring portions that are decoded prior to the portion, such as the left neighbor. In many decoding orders, the left neighboring portion is decoded either immediately prior to the portion or shortly prior to the portion. In such a case, it can be possible to store some of the information from each portion for use in decoding the portions right neighbor.

However, the information needed from the left neighboring portion may not be determinable until after decoding a part of the right neighboring portion.

Other limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

Described herein is a context adaptive binary arithmetic code (CABAC) decoder for decoding macroblock adaptive field/frame coded video data.

In one embodiment, there is presented a video system. The video system comprises a CABAC decoder and neighbor buffer. The CABAC decoder decodes CABAC symbols associated with a portion of a picture, thereby resulting in decoded CABAC symbols. The neighbor buffer stores information from decoded CABAC symbols associated with another portion of the picture, said another portion being adjacent to the portion. The CABAC decoder decodes the CABAC symbols based on the information about the another portion of the picture.

In another embodiment, there is presented an integrated circuit for decoding symbols. The integrated circuit comprises a CABAC decoder and a neighbor buffer. The CABAC decoder is operable to decode CABAC symbols associated with a portion of a picture, thereby resulting in decoded CABAC symbols. The neighbor buffer is connected to the CABAC decoder and is operable to store information from decoded CABAC symbols associated with another portion of the picture, said another portion being adjacent to the portion. The CABAC decoder decodes the CABAC symbols based on the information about the another portion of the picture.

These and other advantages and novel features of the present invention, as well as illustrated embodiments thereof will be more fully understood from the following description and drawings.

### BRIEF DESCRIPTION OF SEVERAL VIEWS OF THE DRAWINGS

Embodiments of the present invention will be better understood from the following description that will refer to the drawings which will now be briefly described. It is noted that unless otherwise indicated, the drawings should not be considered as drawn to scale.

FIG. 1 is a block diagram of an exemplary frame;

FIG. 2A is a block diagram describing spatially predicted macroblocks;

FIG. 2B is a block diagram describing temporally predicted macroblocks;

FIG. 2C is a block diagram describing the encoding of a prediction error;

FIG. 3 is a block diagram describing the encoding of macroblocks for interlaced fields in accordance with macroblock adaptive frame/field coding;

FIG. 4 is a block diagram of a video decoder in accordance with an embodiment of the present invention;

FIG. 5 is a block diagram describing the decoding order for a video decoder in accordance with an embodiment of the present invention;

FIG. 6 is a block diagram describing left neighboring 4×4 partitions;

FIG. 7 is a block diagram describing left neighboring 8×8 partitions;

FIG. 8 is a block diagram describing left neighboring 16×16 macroblocks; and

FIG. 9 is a block diagram describing a CABAC decoder in accordance with an embodiment of the present invention.

### DETAILED DESCRIPTION OF THE INVENTION

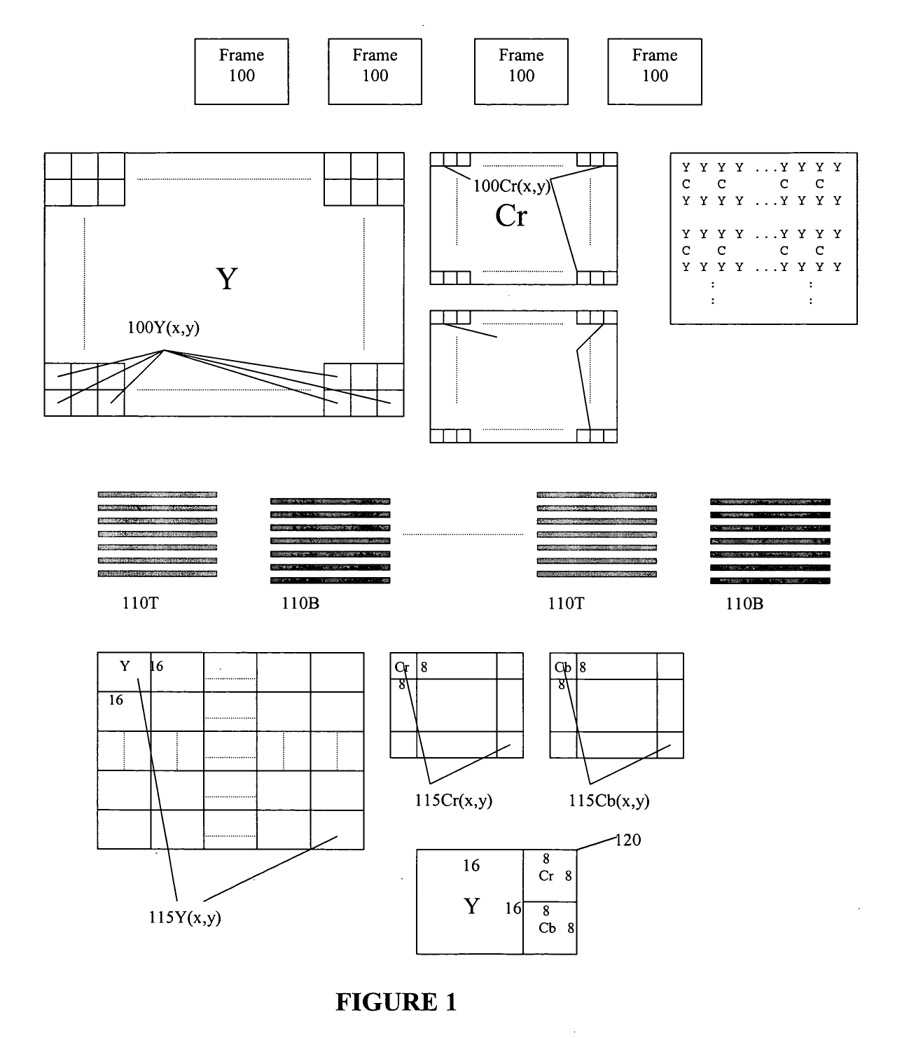

Referring now to FIG. 1, there is illustrated a block diagram of a frame 100. A video camera captures frames 100 from a field of view during time periods known as frame durations. The successive frames 100 form a video sequence. A frame 100 comprises two-dimensional grid(s) of pixels 100 (x,y), by convention with the x coordinate from left to right in the horizontal direction, and the y coordinate from top to bottom in the vertical direction.

For color video, each color component is associated with a two-dimensional grid of pixels. For example, a video can include a luma, chroma red, and chroma blue components. Accordingly, the luma, chroma red, and chroma blue components are associated with a two-dimensional grid of pixels 100Y(x,y), 100Cr(x,y), and 100Cb(x,y), respectively. When the grids of two dimensional pixels 100Y(x,y), 100Cr(x,y), and 100Cb(x,y) from the frame are overlayed on a display device 110, the result is a picture of the field of view at the frame duration that the frame was captured.

Generally, the human eye is more perceptive to the luma characteristics of video, compared to the chroma red and chroma blue characteristics. Accordingly, there are more pixels in the grid of luma pixels 100Y(x,y) compared to the grids of chroma red 100Cr(x,y) and chroma blue 100Cb(x,y). In the ITU-H.264 standard, the grids of chroma red 100Cr(x,y) and chroma blue pixels 100Cb(x,y) have half as many pixels as the grid of luma pixels 100Y(x,y) in each direction.

The chroma red 100Cr(x,y) and chroma blue 100Cb(x,y) pixels are overlayed the luma pixels in each even-numbered column 100Y(2x,2y) one-half a pixel below each even-numbered line 100Y(2x,2y). In other words, the chroma red and chroma blue pixels 100Cr(x,y) and 100Cb(x,y) are overlayed pixels 100Y(2x,2y+ 1/2).

If the video camera is interlaced, the video camera captures the even-numbered lines 100Y(x,2y), 100Cr(x,2y), and 100Cb(x,2y) during half of the frame duration (a field duration), and the odd-numbered lines 100Y(x,2y+1), 100Cr(x,2y+1), and 100Cb(x,2y+1) during the other half of the frame duration. The even numbered lines 100Y(x,2y), 100Cr(x,2y), and 100Cb(x,2y) form what is known as a top field 110T, while odd-numbered lines 100Y(x,2y+1), 100Cr(x,2y+1), and 100Cb(x,2y+1) form what is known as the bottom field 110B. The top field 110T and bottom field 110T are also two dimensional grid(s) of luma 110YT(x,y), chroma red 110CrT(x,y), and chroma blue 110CbT(x,y) pixels.

Luma pixels of the frame 100Y(x,y), or top/bottom fields 110YT/B(x,y) can be divided into 16×16 pixel 100Y(16x->16x+15, 16y->16y+15) blocks 115Y(x,y). For each block of luma pixels 115Y(x,y), there is a corresponding 8×8 block of chroma red pixels 115Cr(x,y) and chroma blue pixels 115Cb(x,y) comprising the chroma red and chroma blue pixels that are to be overlayed the block of luma pixels 115Y(x,y). A block of luma pixels 115Y(x,y), and the corresponding blocks of chroma red pixels 115Cr(x,y) and chroma blue pixels 115Cb(x,y) are collectively known as a macroblock 120.

The ITU-H.264 Standard (H.264), also known as MPEG-4, Part 10, or as Advanced Video Coding, encodes video on a frame by frame basis, and encodes frames on a macroblock by macroblock basis. H.264 specifies the use of spatial prediction, temporal prediction, integer transform, and lossless entropy coding to compress the macroblocks 120.

Spatial Prediction

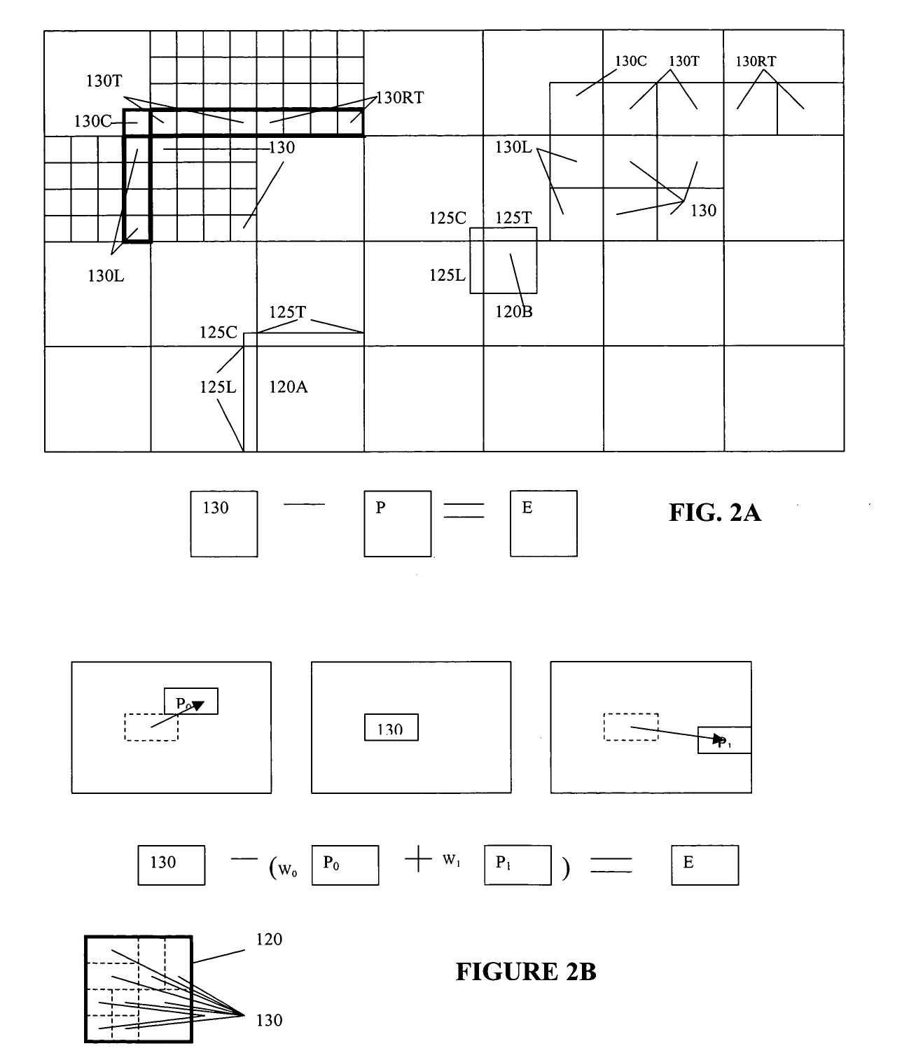

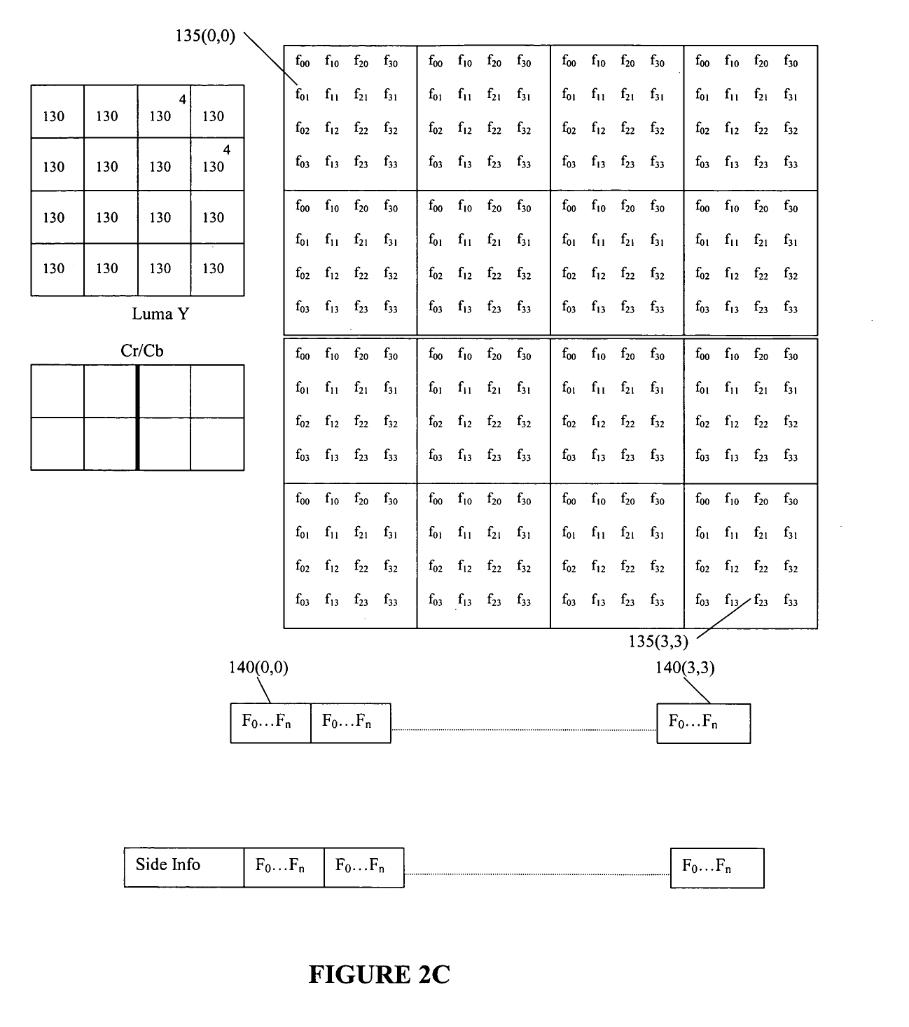

Referring now to FIG. 2A, there is illustrated a block diagram describing spatially encoded macroblocks 120. Spatial prediction, also referred to as intraprediction, involves prediction of frame pixels from neighboring pixels. The pixels of a macroblock 120 can be predicted, either in a 16×16 mode, an 8×8 mode, or a 4×4 mode.

In the 16×16 and 8×8 modes, e.g, macroblock 120A, and 120B, respectively, the pixels of the macroblock are predicted from a combination of left edge pixels 125L, a corner pixel 125C, and top edge pixels 125T. The difference between the macroblock 120A and prediction pixels P is known as the prediction error E. The prediction error E is calculated and encoded along with an identification of the prediction pixels P and prediction mode, as will be described.

In the 4×4 mode, the macroblock 120A is divided into 4×4 partitions 130. The 4×4 partitions 130 of the macroblock 120A are predicted from a combination of left edge partitions 130L, a corner partition 130C, right edge partitions 130R, and top right partitions 130TR. The difference between the macroblock 120A and prediction pixels P is known as the prediction error E. The prediction error E is calculated and encoded along with an identification of the prediction pixels and prediction mode, as will be described. A macroblock 120 is encoded as the combination of the prediction errors E representing its partitions 130.

Temporal Prediction

Referring now to FIG. 2B, there is illustrated a block diagram describing temporally encoded macroblocks 120. The temporally encoded macroblocks 120 can be divided into various combinations of 16×8, 8×16, 8×8, 4×8, 8×4, and 4×4 partitions 130. Each partition 130 of a macroblock 120, is compared to the pixels of other frames or fields for a similar block of pixels P. A macroblock 120 is encoded as the combination of the prediction errors E representing its partitions 130.

The similar block of pixels is known as the prediction pixels P. The difference between the partition 130 and the prediction pixels P is known as the prediction error E. The prediction error E is calculated and encoded, along with an identification of the prediction pixels P. The prediction pixels P are identified by motion vectors MV. Motion vectors MV describe the spatial displacement between the partition 130 and the prediction pixels P. The motion vectors MV can, themselves, be predicted from neighboring partitions.

The partition can also be predicted from blocks of pixels P in more than one field/frame. In bi-directional coding, the partition 130 can be predicted from two weighted blocks of pixels, P0 and P1. Accordingly, a prediction error E is calculated as the difference between the weighted average of the prediction blocks w0P0+w1p1 and the partition 130. The prediction error E, and an identification of the prediction blocks P0, P1 are encoded. The prediction blocks P0 and P1 are identified by motion vectors MV.

The weights w0, w1 can also be encoded explicitly, or implied from an identification of the field/frame containing the prediction blocks P0 and P1. The weights w0, w1 can be implied from the temporal distance between the frames/fields containing the prediction blocks P0 and P1 and the frame/field containing the partition 130. Where T0 is the number of frame/field durations between the frame/field containing P0 and the frame/field containing the partition, and T1 is the number of frame/field durations for P1,
w0=1−T0/(T0+T1)
w1=1−T1/(T0+T1)
Transform, Quantization, and Scanning

Referring now to FIG. 2C, there is illustrated a block diagram describing the encoding of the prediction error E. With both spatial prediction and temporal prediction, the macroblock 120 is represented by a prediction error E. The prediction error E is also two-dimensional grid of pixel values for the luma Y, chroma red Cr, and chroma blue Cb components with the same dimensions as the macroblock 120.

The integer transform transforms 4×4 partitions 130(0,0) . . . 130(3,3) (for luma) and additional partitions 130(0,0) . . . 130(1,1) for each of the chroma red and chroma blue, of the prediction error E to the frequency domain, thereby resulting in corresponding sets 135(0,0) . . . 135(3,3) of frequency coefficients f₀₀ . . . f₃₃ (135(0,0) . . . 135(1,1) for each of the chroma components). The sets of frequency coefficients are then quantized and scanned, resulting in sets 140(0,0) . . . 140(3,3) of quantized frequency coefficients for luma, F₀ . . . Fₙ, and sets 140(0,0) . . . 140(1,1) of quantized frequency coefficients for each of the chroma components. A macroblock 120 is encoded as the combination of its partitions 130.

Macroblock Adaptive Frame/Field (MBAFF) Coding

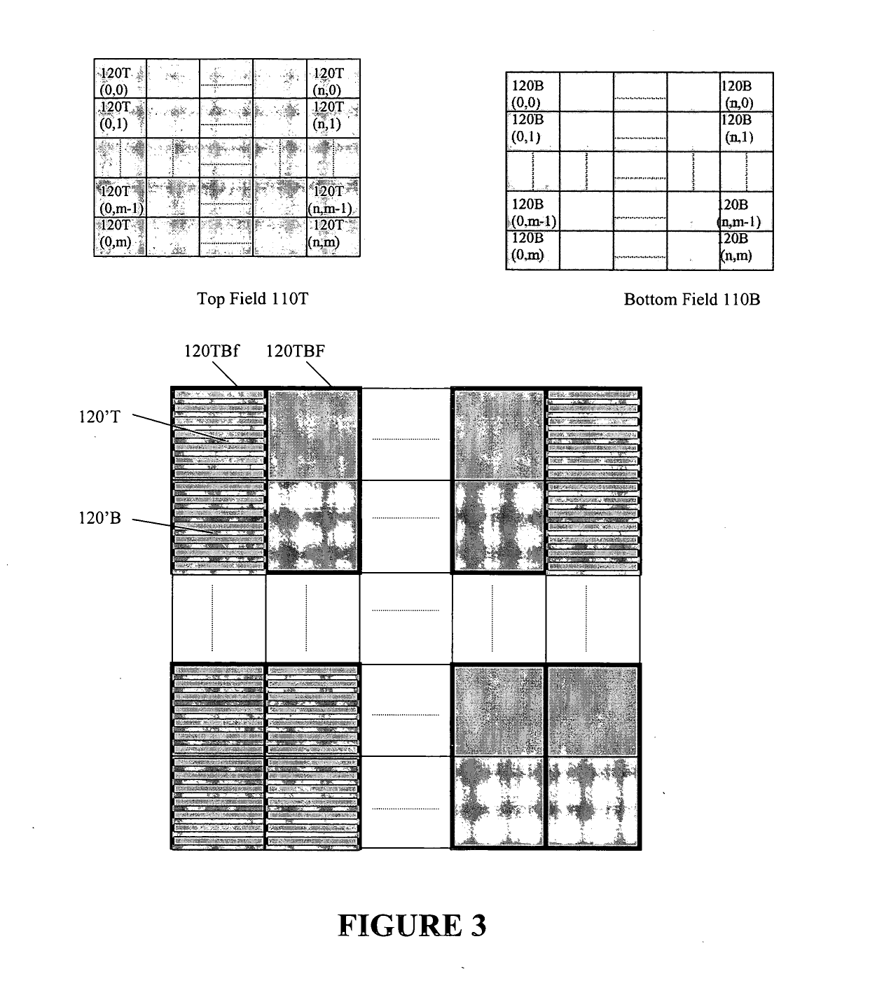

Referring now to FIG. 3, there is illustrated a block diagram describing the encoding of macroblocks 120 for interlaced fields. As noted above, interlaced fields, top field 110T(x,y) and bottom field 110B(x,y) represent either even or odd-numbered lines.

In MBAFF, macroblocks 120 are processed in pairs. Each macroblock 120T in the top field is paired with the macroblock 120B in the bottom field, that is interlaced with it. The macroblocks 120T and 120B are then coded as a macroblock pair 120TB. The macroblock pair 120TB can either be field coded, macroblock pair 120TBF or frame coded, macroblock pair 120TBf. Where the macroblock pair 120TBF are field coded, the macroblock 120T is encoded, followed by macroblock 120B. Where the macroblock pair 120TBf are frame coded, the macroblocks 120T and 120B are deinterlaced. The foregoing results in two new macroblocks 120′T, 120′B. The macroblock 120′T is encoded, followed by macroblock 120′B.

Entropy Coding

Referring again to FIG. 2C, the macroblocks 120 are represented by a prediction error E that is encoded as sets 140(0,0) . . . 140(3,3) of quantized frequency coefficients F₀ . . . Fₙ. The representation for macroblocks 120 also includes side information, such as prediction mode indicators, and identification of prediction blocks.

The foregoing are encoded using either Context Adaptive Variable Length Coding (CAVLC) or Context Adaptive Binary Arithmetic Coding (CABAC). The frames 100 are encoded as the macroblocks 120 forming them, and side information such as the type of frame. The video sequence is encoded as the frames forming it, and side information, such as the frame size. The encoded video sequence is known as a video elementary stream. The video elementary stream is a bitstream that can be transmitted over a communication network to a decoder. Transmission of the bitstream instead of the video sequence consumes substantially less bandwidth.

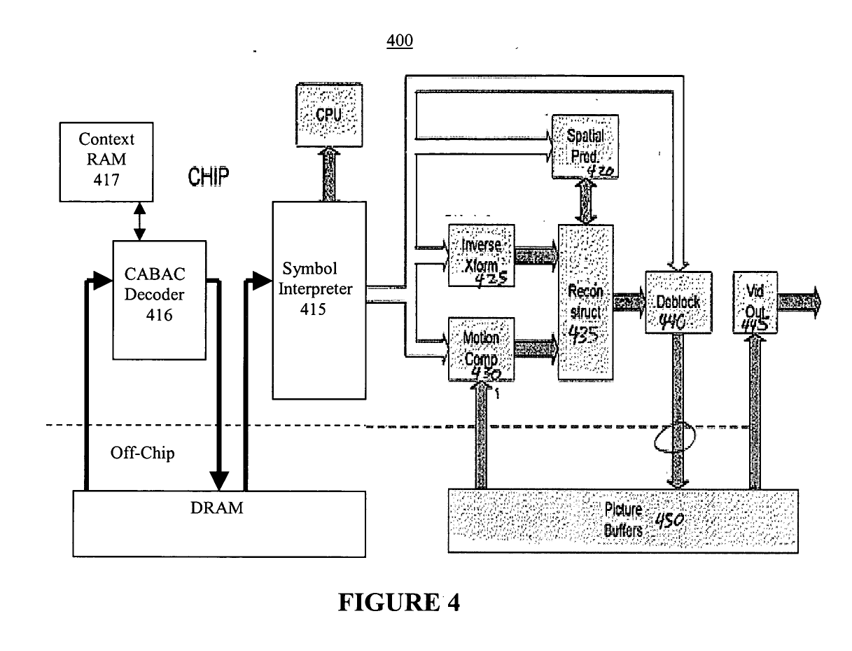

Referring now to FIG. 4, there is illustrated a block diagram describing an exemplary video decoder 400 in accordance with an embodiment of the present invention. The video decoder 400 receives the video elementary stream from a code buffer. The code buffer can be a portion of a memory system, such as a dynamic random access memory (DRAM).

A CABAC decoder 416 retrieves CABAC data and decodes the CABACdata, thereby generating what are known as CABAC BINS. The CABAC decoder 416 writes the CABAC BINS to the DRAM. The CABAC decoder 416 also maintains an on-chip context RAM 417 to indicate the likelihood of ones and zeroes for different BINS.

A symbol interpreter 415 converts the CABAC BINS to sets of scanned quantized frequency coefficients, and provides the sets of scanned quantized frequency coefficients F₀ . . . Fₙ to an inverse scanner, quantizer, and transform 425. Depending on the prediction mode for the macroblock 120 associated with the scanned quantized frequency coefficients F₀ . . . Fₙ, the symbol interpreter 415 provides the side information to either a spatial predicter 420 (if spatial prediction) or a motion compensator 430 (if temporal prediction).

The transform 425 constructs the prediction error E. The spatial predictor 420 generates the prediction pixels P for spatially predicted macroblocks while the motion compensator 430 generates the prediction pixels P, or P0, P1 for temporally predicted macroblocks. The motion compensator 430 retrieves the prediction pixels P, or P0, P1 from picture buffers 450 that store previously decoded frames 100 or fields 110.

A pixel reconstructor 435 receives the prediction error E from the transform 425, and the prediction pixels from either the motion compensator 430 or spatial predictor 420. The pixel reconstructor 435 reconstructs the macroblock 120 from the foregoing information and provides the macroblock 120 to a deblocker 440. The deblocker 440 smoothes pixels at the edge of the macroblock 120 to prevent the appearance of blocking. The deblocker 440 writes the decoded macroblock 120 to the picture buffer 450.

A display engine 445 provides the frames 100 from the picture buffer 450 to a display device. The symbol interpreter 415, the transform 425, spatial predictor 420, motion compensatory 430, pixel reconstructor 435, and display engine 445 can be hardware accelerators under the control of a central processing unit (CPU).

As noted above, the CABAC decoder 416 decodes the side information for partitions 130. However, the CABAC coding of the side information for a partition, e.g., partition 130(x,y), depends on the side information from the top neighbor partition, 130(x,y−1), and left neighboring partition, 130(x−1,y). In the case of the row of partitions 130(x,0) at the top of a macroblock, information from the bottom line 130(x,3) of the above macroblock is needed. In the case of the column of partitions 130(0,y) at the left of a macroblock, information from the right edge 130(3,y) of the right neighboring macroblock is needed. As also noted above, the partitions can be 4×4, 8×8, and 16×16 pixels.

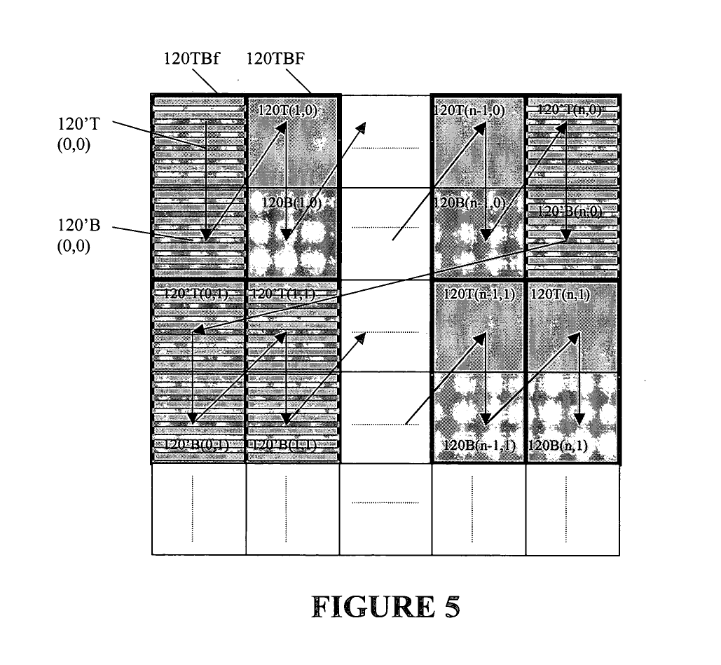

Referring now to FIG. 5, there is illustrated a block diagram describing the decoding order of the video decoder, in accordance with an embodiment of the present invention. For interlaced fields 110T, 110B with MBAFF encoding, the video decoder 400 decodes the macroblocks in pairs, starting with the macroblock pair 120T(0,0), 120B(0,0) at the top corners of the top field 110T and bottom field 110B and proceeding across the top row of macroblocks 120T(n,0), 120B(n,0n). The video decoder 400 then proceeds to the left most macroblock of the next row of macroblocks 120T(0, 1), 120B(0,1) and proceeds to the right, and so forth.

The macroblock pairs represent 32×16 pixel blocks of the frame 100. However, where the macroblock pairs are frame coded, such as macroblocks 120TBf, the reconstructed macroblocks 120′T(0,0), 120′B(0,0) represented the top and bottom halves of macroblocks 120T(0,0) and 120B(0,0) deinterlaced. Macroblock 120′T(0,0) includes the first eight lines of pixels from macroblocks 120T(0,0) and 120B(0,0). Macroblock 120′B(0,0) includes the last eight lines of pixels from macroblocks 120T(0,0) and 120B(0,0).

As noted above, the CABAC coding for partitions 130 is dependent on the top and left neighboring partitions. The CABAC coding of the top row and left column of partitions in a macroblock 120 depends on the bottom row of partitions of the top neighboring macroblock and the right column of partitions of the left neighboring macroblock.

The location of the bottom row of partitions of the top neighboring macroblock and the right column of partitions of the left neighboring macroblock depend on whether the macroblock pair, the left neighboring macroblock pair, and the top neighboring macroblock pair are frame or field coded.

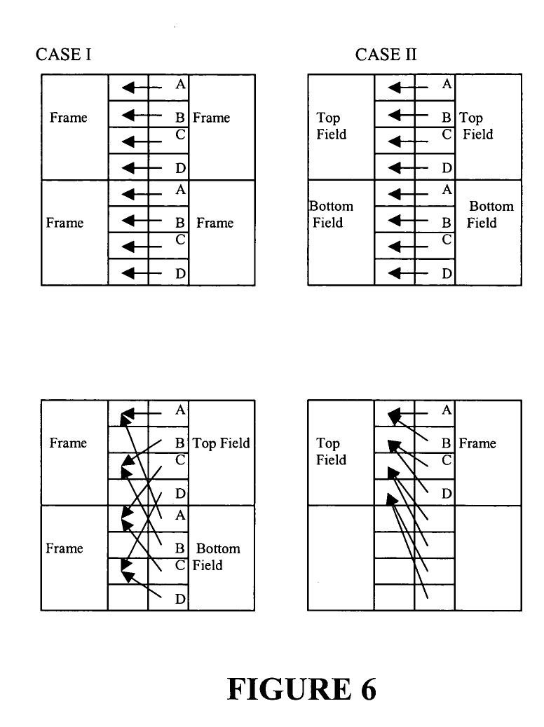

Referring now to FIG. 6, there is illustrated a block diagram describing the left neighboring 4×4 partitions for the left partitions in macroblock pairs 120TB. In case 1, the macroblock pair 120TB and its left neighbor macroblock pair 120TB are both frame coded. The left neighbor partitions for partitions A, B, C, D are as indicated by the arrows.

In case 2, the macroblock pair 120TB and its left neighbor macroblock pair 120TB are both field coded. The left neighbor partitions for partitions A, B, C, D are as indicated by the arrows.

In case 3, the macroblock pair 120TB is frame coded while its left neighbor macroblock pair 120TB is field coded. The left neighbor partitions for partitions A, B, C, D are as indicated by the arrows.

In case 4, the macroblock pair 120TB is frame coded while its left neighbor macroblock pair 120TB is field coded. The left neighbor partitions for partitions A, B, C, D are as indicated by the arrows.

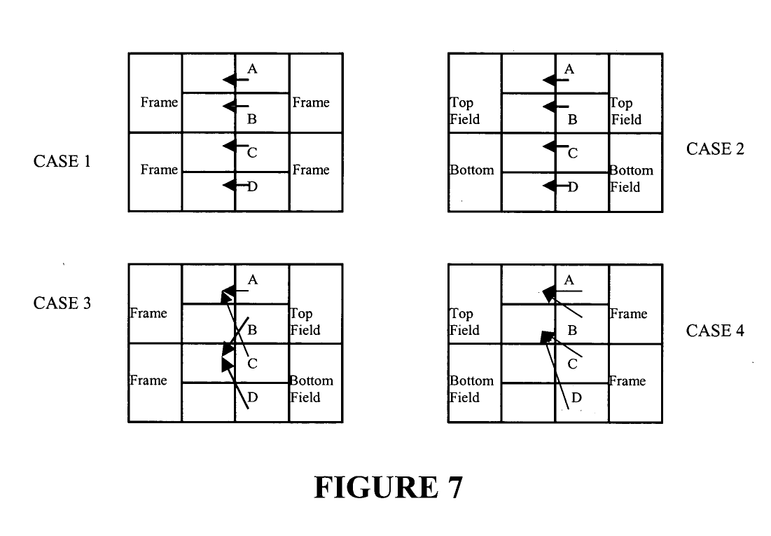

Referring now to FIG. 7, there is illustrated a block diagram describing the left neighboring 8×8 partitions for the left partitions in macroblock pairs 120TB. In case, 1, the macroblock pair 120TB and its left neighbor macroblock pair 120TB are both frame coded. The left neighbor partitions for partitions A, B, C, D are as indicated by the arrows.

In case 2, the macroblock pair 120TB and its left neighbor macroblock pair 120TB are both field coded. The left neighbor partitions for partitions A, B, C, D are as indicated by the arrows.

In case 3, the macroblock pair 120TB is frame coded while its left neighbor macroblock pair 120TB is field coded. The left neighbor partitions for partitions A, B, C, D are as indicated by the arrows.

In case 4, the macroblock pair 120TB is frame coded while its left neighbor macroblock pair 120TB is field coded. The left neighbor partitions for partitions A, B, C, D are as indicated by the arrows.

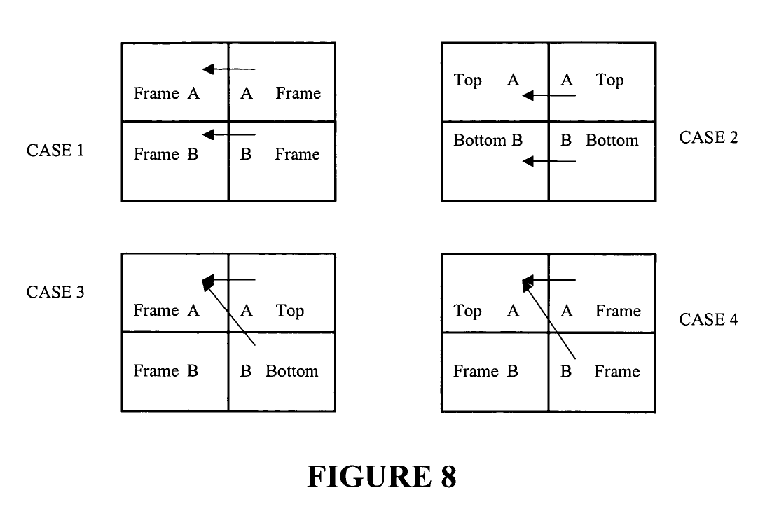

Referring now to FIG. 8, there is illustrated a block diagram describing the left neighboring 16×16 partitions for the left partitions in macroblock pairs 120TB. In case 1, the macroblock pair 120TB and its left neighbor macroblock pair 120TB are both frame coded. The left neighbor partitions for partitions A, B, C, D are as indicated by the arrows.

In case 2, the macroblock pair 120TB and its left neighbor macroblock pair 120TB are both field coded. The left neighbor partitions for partitions A, B, C, D are as indicated by the arrows.

In case 3, the macroblock pair 120TB is frame coded while its left neighbor macroblock pair 120TB is field coded. The left neighbor partitions for partitions A, B, C, D are as indicated by the arrows.

In case 4, the macroblock pair 120TB is frame coded while its left neighbor macroblock pair 120TB is field coded. The left neighbor partitions for partitions A, B, C, D are as indicated by the arrows.

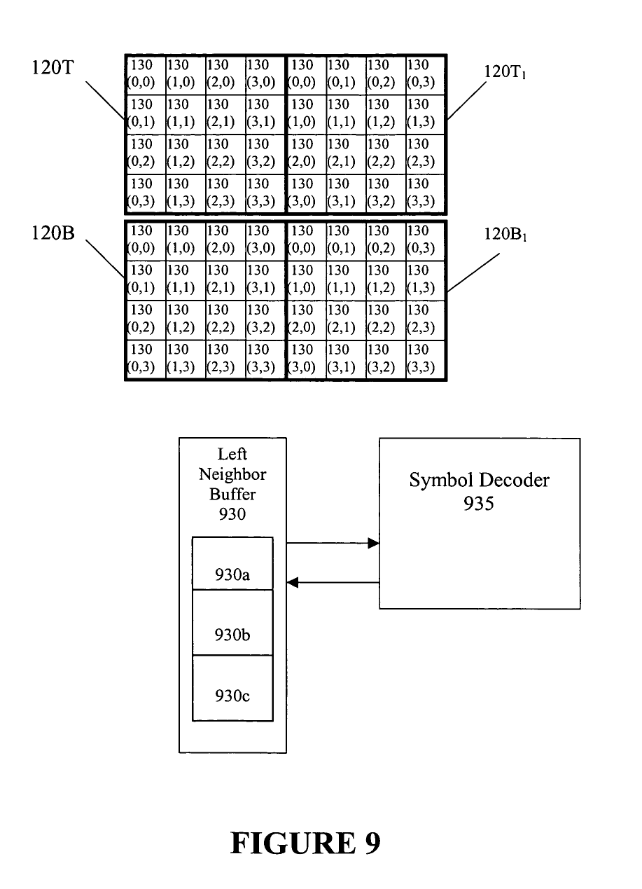

Referring now to FIG. 9, there is illustrated a block diagram describing certain aspects of the CABAC decoder 416 in accordance with an embodiment of the present invention. The CABAC decoder 416 includes a left neighbor buffer 930 and a symbol decoder 935.

The symbol decoder 935 decodes the CABAC symbols encoding the partitions 130. The CABAC decoder 415B receives the video data on a macroblock by macroblock 120 basis.

After the CABAC decoder 416 decodes the CABAC coding for a macroblock 120T or 120B, the CABAC decoder 416 writes information for each partition 130(3,y) to the left neighbor buffer 930. The symbol decoder 935 uses the foregoing information, as well as information regarding the top neighboring partition (fetched from DRAM) to decode the CABAC coding of the next macroblock pair 120T₁, 120B₁. According to certain aspects of the present invention, decoding of the CABAC data can be converting the CABAC data to CABAC BINS, in which case, the decoded CABAC data comprise CABAC BINS.

The symbol decoder 935 uses the information stored for the particular ones of the right column partitions 130(3,y) of macroblocks 120T and 120B to decode CABAC coding for partitions 130(0,y) of macroblock 120T. The particular ones of the right column partitions 130(3,y) of macroblock 120T and 120B are selected based on whether the coding type (field/frame) of each macroblock pair, as indicated in the FIG. 6, 7, or 8.

The left neighbor buffer 930 can include a double buffer, wherein one half 930a stores information from the rightmost partitions 130(3,y) of the most recently completed macroblock, and the other half 930b stores information from the rightmost partitions 130(3,y) of the second most recently completed macroblock. After a macroblock is decoded, buffer half 930a is copied to buffer half 930a, and information from the rightmost partitions 130(3,y) is written to buffer half 930a.

Subsequently, when macroblock 120T₁ or 120B₁ is decoded, buffer half 930b contains the left neighbor information from macroblock 120T or 120B, respectively. Thus, if macroblock pair 120TB and macroblock pair 120TB₁ are both field coded or both frame coded, buffer half 930b contains the correct neighbor information, as can be seen from FIGS. 6, 7, and 8.

If macroblock pair 120TB is field coded and macroblock pair 120TB₁ is frame coded, or vice versa, and macroblock 120T₁ or macroblock 120B is to be decoded, the correct neighbor information can be established in all corresponding partitions 130(3,y) in buffer half 930b by copying the correct data from other partitions 130(3,y) within buffer halves 930b and 930a, before the macroblock 120T₁ or 120B₁ is decoded. In some cases, the data for macroblock 120T in buffer half 930b that is overwritten by the copy operation may be needed subsequently when decoding macroblock 120B₁. This data can be saved to a third buffer section 930c before the copy operation for macroblock 120T₁ and copied back into buffer 930b before it is needed for decoding macroblock 120B₁.

The particular partition information and side information in buffer half 930a is described with the following constructs, using the syntax and semantics of the commonly used Verilog hardware description language:

| | |
|---|---|
| reg [4:0] | left_mb_mb_type [1:0]; // 2 copies, |

one for top MB, one for bottom, in mbaff mode

| | |
|---|---|
| reg [1:0] | left_mb_b8mode_eq_0; // [2] = |

[y_index] [x==1]

| | |
|---|---|
| reg [1:0] | left_mb_b8pdir_eq_2; // [2] = |

[y_index] [x==1]

| | |
|---|---|
| reg [3:0] | left_mb_c_ipred_mode; |
| reg | left_mb_skip_flag; |
| reg [5:0] | left_mb_cbp; // coded block |

pattern

| | |
|---|---|
| reg [26:0] | left_mb_cbf_bits; // coded block |

flag

| | |
|---|---|
| reg [6:0] | left_mb_mvd[63:0] ; // [2] [4] [4] [2] |

= [list_idx] [y_index] [x_index] [y=1, x=0]

| | |
|---|---|
| reg [6:0] | left_mb_mvd[15:0] ; // [2] [4] [2] |

= [list_idx] [y_index] [x=3 ] [y=1, x=0]

| | |
|---|---|
| reg | left_mb_mb_field; // used in mbaff |

mode

| | |
|---|---|
| reg [7:0] | left_mb_ref_fr_gt_0; // [2] [4] = |

[list_idx] [y_index] [x=3 ]

| | |
|---|---|
| reg [7:0] | left_mb_ref_fr_gt_1; // [2] [4] = |

[list_idx] [y_index] [x=3 ]

The information in buffer half 930b is similar.

The embodiments described herein may be implemented as a board level product, as a single chip, application specific integrated circuit (ASIC), or with varying levels of the decoder system integrated with other portions of the system as separate components. The degree of integration of the decoder system will primarily be determined by the speed and cost considerations. Because of the sophisticated nature of modern processor, it is possible to utilize a commercially available processor, which may be implemented external to an ASIC implementation. If the processor is available as an ASIC core or logic block, then the commercially available processor can be implemented as part of an ASIC device wherein certain functions can be implemented in firmware. Alternatively, the functions can be implemented as hardware accelerator units controlled by the processor.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A video system comprising:
a CABAC decoder for decoding CABAC data associated with a portion of a picture, thereby resulting in CABAC symbols; and
a neighbor buffer for storing information from decoded CABAC symbols associated with another portion of the picture, said another portion being adjacent to the portion; and
wherein the CABAC decoder decodes the CABAC symbols based on the information about the another portion of the picture.

2. The video system of claim 1, wherein the CABAC decoder decodes CABAC symbols associated with the portion of the picture and the another portion of the picture consecutively, wherein the CABAC decoder decodes the CABAC symbols associated with the another portion before decoding the CABAC symbols associated with the portion.

3. The video system of claim 1, wherein the portion and the another portion each comprise two macroblocks.

4. The video system of claim 3, wherein the macroblocks of the portion are field coded.

5. The video system of claim 3, wherein the macroblocks of the another portion are field coded.

6. The video system of claim 3, wherein the macroblocks of the another portion are frame coded.

7. The video system of claim 3, wherein the macroblocks of the another portion are frame coded.

8. The video system of claim 1, wherein the CABAC decoder decodes CABAC symbols from a third portion of the picture based on information from the CABAC symbols associated with the portion of the picture.

9. The video system of claim 1, wherein the decoded CABAC symbols comprise CABAC BINS.

10. A integrated circuit for decoding symbols, said integrated circuit comprising:
a CABAC decoder operable to decode CABAC data associated with a portion of a picture, thereby resulting in decoded CABAC symbols; and
a neighbor buffer connected to the CABAC decoder, the neighbor buffer operable to store information from decoded CABAC symbols associated with another portion of the picture, said another portion being adjacent to the portion;
wherein the CABAC decoder decodes the CABAC symbols based on the information about the another portion of the picture.

11. The integrated circuit of claim 10, wherein the CABAC decoder is operable to decode CABAC symbols associated with the portion of the picture and the another portion of the picture consecutively, and wherein the CABAC decoder is operable to decode the CABAC symbols associated with the another portion before decoding the CABAC symbols associated with the portion.

12. The integrated circuit of claim 10, wherein the portion and the another portion each comprise two macroblocks.

13. The integrated circuit of claim 12, wherein the macroblocks of the portion are field coded.

14. The integrated circuit of claim 12, wherein the macroblocks of the another portion are field coded.

15. The integrated circuit of claim 12, wherein the macroblocks of the another portion are frame coded.

16. The integrated circuit of claim 12, wherein the macroblocks of the another portion are frame coded.

17. The integrated circuit of claim 10, wherein the CABAC decoder is operable to decode CABAC symbols from a third portion of the picture based on information from the CABAC symbols associated with the portion of the picture.

18. The integrated circuit of claim 10, wherein the decoded CABAC symbols comprise CABAC BINS.
